(19) United States
(12) Patent Application Publication
(10) Pub. No.: US 2007/0147297 A1
(43) Pub. Date: Jun. 28, 2007

(54) Dynamic baseline technique for analyzing wireless networks

(76) Inventors: Alvaro H. Diaz, Holmdel, NJ (US); Michael J. Flanagan, Chester, NJ (US); Jayanthi Srinivasan, Morristown, NJ (US)

Correspondence Address: CARLSON, GASKEY & OLDS, P.C., 400 W MAPLE RD, SUITE 350, BIRMINGHAM, MI, 48009, US

(21) Appl. No.: 11/319,761

(22) Filed: Dec. 28, 2005

(51) Int. Cl. H04Q 7/00

(52) U.S. Cl. 370/331

(57) ABSTRACT

The technique for analyzing a live wireless network (20) includes repeatedly alternating (54, 60) between a baseline network configuration (52, 58, 64) and a trial network configuration (56, 62) a plurality of times within a twenty-four hour period. A disclosed example includes repeatedly alternating between the baseline network configuration and the trial network configuration such that each network configuration is used for a sample period that lasts about one hour. In one example, the pattern of alternating between the trial and baseline network configurations is determined randomly while in another example each network configuration is used in a preselected pattern such as every other hour.

### FIELD OF THE INVENTION

This invention generally relates to communications. More particularly, this invention relates to wireless communications.

### DESCRIPTION OF THE RELATED ART

Wireless communication systems are well known and in widespread use. Typical systems include a variety of components that each serve their intended function to facilitate wireless communications on behalf of one or more mobile stations such as cell phones. With increasing popularity and increasing competition, wireless communication providers are constantly striving to improve their systems. From time to time it is desirable to make a change to a system in an attempt to enhance performance.

The traditional approach has been to implement a change on a trial basis to assess the technical and financial benefits of such a change. The common approach is to gather performance information over an investigation period lasting from weeks to months using the current system configuration. Corresponding performance information is gathered over another investigation period of similar duration during which the new or changed system configuration is used on a trial basis. A comparison between the information gathered over the respective periods provides information regarding whether it is beneficial to implement the change on a permanent basis. There are several shortcomings associated with this approach.

A significant challenge when attempting to assess the benefit of a change to a wireless communication system is addressing the fluctuations that occur in customer usage of the system over time. There is no way to control the amount of traffic in a manner that would provide a comparison of relatively equal quantities over the respective investigation periods. For example, if the information gathered regarding the current system configuration occurs during August while the information gathered regarding the change to the system occurs during September, the separation in time will almost certainly include different volumes of traffic among other variations. Depending on the location, August may be a less busy month because more people are on vacation compared to September as people return to work and school. There will be different geographical or spatial distributions of users over time (e.g., traffic volumes will vary at locations such as a beach or recreation center, depending on the time of year). Additionally, there typically has been growth in the amount of traffic (i.e., an increasing number of subscribers, more usage by existing subscribers or both) from month to month. Further, some months include special holidays that affect the amount of wireless service usage.

The differences occurring in system usage over the respective investigation time periods for analyzing the current system configuration and the changed system configuration limits the accuracy of comparisons made between the performance information gathered over those times.

There is a need for an improved technique for analyzing in a robust manner whether a change to a wireless communication system will prove to provide better performance, improved service to customers, better economies or a combination of these. This invention addresses that need.

### SUMMARY OF THE INVENTION

An exemplary method of communicating includes repeatedly alternating between a baseline network configuration and a trial network configuration a plurality of times within a twenty-four hour period.

In one example, a selected sample period duration is within a range from about fifteen minutes to about four hours. Each use of the baseline and trial network configuration lasts for the selected sample period duration. In one example, the sample period duration is about one hour such that the method includes alternating between the baseline network configuration and the trial network configuration every hour.

One example includes alternating times during which the baseline network configuration on the one hand and the trial network configuration on the other hand is used from day-to-day. For example, on every other day certain time slots within which the baseline network configuration is used are used for the trial network configuration. The same time slot will have the baseline configuration one day and the trial network configuration the next day.

By more often alternating between a trial network configuration and a baseline network configuration, the example method reduces the impact of variations in traffic volumes over time upon an analysis for comparing the baseline and trial network configurations.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a wireless communication system that is useful with an example embodiment of this invention.

FIG. 2 graphically illustrates one example technique for assessing the benefits associated with a contemplated change to a wireless communication network.

### DETAILED DESCRIPTION

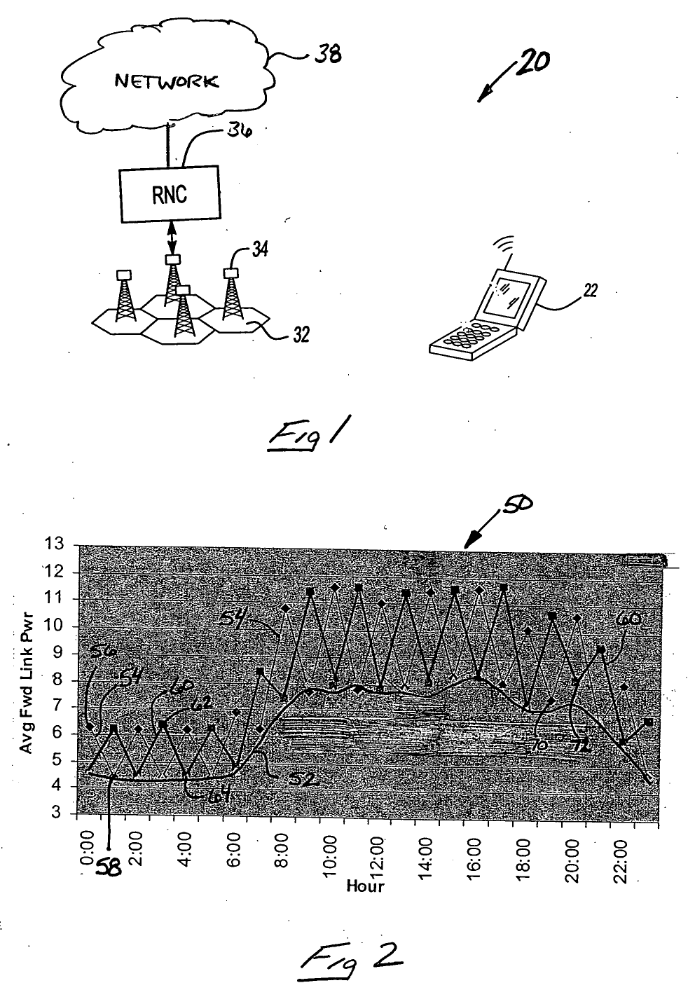

FIG. 1 schematically shows selected portions of a wireless communication system 20 that facilitates communications on behalf of one or more mobile stations 22. As known, a geographic region is divided into a plurality of cells 32. In the illustrated example, each cell 32 is served by a base station 34 including a radio tower and at least one antenna. The example base stations are controlled by a controller 36 such as a radio network controller. A network 38 includes known components that facilitate communications on behalf of the mobile station 22 with other mobile stations or traditional line-based telephones, for example.

From time to time it will be beneficial to consider whether a change to one or more portions of the system 20 will be beneficial. A new system configuration may include, for example, a change to one or more antenna azimuths, antenna tilts, antenna beamwidths, transmit power levels and call translation parameters. Other new system features may include overload control algorithms, call processing techniques or new hardware. The use of any one or more of such changes provides a new system configuration (based on at least one new or changed portion of the system) compared to a currently used configuration. This description refers to any such change as providing a trial network configuration and refers to the currently used configuration as a baseline network configuration. The trial network configuration will be used on a periodic basis so that an assessment can be made whether the proposed change provides enhancements as desired compared to the corresponding baseline network configuration.

Alternating between the trial network configuration and the baseline network configuration in this example occurs much more often than with conventional approaches.

FIG. 2 graphically illustrates one example technique where a graph 50 shows repeatedly alternating between a baseline network configuration and a trial network configuration. A curve 52 shows a baseline network configuration average forward link power over time. The graph 50 in FIG. 2 covers a 24 hour time period. If the baseline network configuration were used continuously, the average forward link power would follow the curve 52 during a normal day. With the example implementation of this invention, however, the average forward link power varies between values corresponding to the baseline configuration and values corresponding to the trial network configuration.

A first plot 54 shows variations between a trial network configuration average forward link power at 56 and the baseline network configuration average forward link power at 58. In this example, during one day, the plot 54 includes a technique that involves utilizing the trial network configuration for every even numbered hour during a twenty-four hour day and using the baseline network configuration for each odd numbered hour during the same twenty-four hour day.

For example, the average forward link power associated with a trial network configuration as shown at 56 is utilized during the hour from midnight to 1:00 a.m., then from the 2:00 a.m. to 3:00 a.m. hour, then during the 4:00 a.m. to 5:00 a.m. hour, etc. During the same day, the baseline network configuration shown at 58 is used between 1:00 a.m. and 2:00 a.m., then between 3:00 a.m. and 4:00 a.m., and then between 5:00 a.m. and 6:00 a.m., etc. Repeatedly alternating between the baseline network configuration and the trial network configuration throughout the twenty-four hour period essentially eliminates the differences between network usage occurring during the time periods associated with each of the network configurations. Repeatedly alternating between the trial network configuration and the baseline network configuration within a twenty-four hour period essentially eliminates the effect of the fluctuations that skewed comparison data between investigation periods of several weeks or months within traditional approaches.

The illustrated example includes alternating between the trial network configuration and the baseline network configuration such that each configuration is used every other sample period (e.g., every other hour). Another example includes randomly selecting which of the network configurations will be used for each sample time period (e.g., each hour). In such an example, some measures are taken to ensure that an equal number of sample time periods are utilized for each of the network configurations over an entire testing period such as a week or a month.

In the illustrated example, each sample time duration is one hour. Example implementations of this invention include using sample time durations ranging between fifteen minutes and about four hours. One hour sample time durations are used in some examples because many wireless network analysts consider hourly increments. Such example implementations of this invention, therefore, fit nicely within the traditional time blocks used for other purposes when analyzing wireless communication networks.

The length of the sample period will depend, in part, on the nature of the change associated with the trial network configuration. Some changes will be more readily implemented, allowing shorter sample period durations. Others will require longer sample periods. Those skilled in the art who have the benefit of this description will be able to select an appropriate sample period duration to meet their particular needs while providing sufficient network stability.

The example of FIG. 2 includes a second plot 60 showing repeatedly alternating between an average forward link power of a trial network configuration at 62 and a baseline network configuration average forward link power at 64. One feature of this example is that the plot 60 may be used on one day while the plot 54 may be used on a subsequent day. In other words, the example of FIG. 2 includes not only repeatedly alternating between the trial network configuration and the baseline network configuration throughout a day but then altering the pattern of such alternation on a day-to-day basis.

For example, all even numbered days of a month may include using the plot 54 to dictate how to alternate between the trial network configuration and the baseline network configuration. All odd numbered days may include using the plot 60 for controlling how to alternate between the two network configurations. This example includes utilizing the trial network configuration during the even numbered hours on one day and the baseline network configuration during those same hours on another day. This approach further reduces the likelihood that different traffic patterns will skew or distort the information gathered for purposes of analyzing differences between the network configurations for making the determination regarding the benefits of the proposed change being considered through use of the trial network configuration.

As shown at 70 and 72, for example, the actual average forward link power for the baseline network configuration may vary from the exact value of the curve 52 within acceptable limits.

Another advantage of the disclosed example is that it allows for a wider variety of analysis techniques when considering different performance characteristics of the different network configurations. With traditional testing techniques, the periods of several weeks or months only allow for an aggregate, average analysis of the difference between a trial network configuration and a currently used (e.g., baseline) network configuration. With the example implementation of this invention, such aggregate, average analysis is possible with greater accuracy and more meaningful results. Moreover, specific analysis may be done on any selected performance characteristic to make finer interval assessments associated with a specific change between the network configurations. For example, the number of dropped calls can be analyzed on a day-by-day basis, which is a significant improvement over the ability to look at dropped calls over a period of several weeks or months. Additionally, it is possible to obtain uncertainty information to determine the certainty with which the specific change is being analyzed. For example, using the example technique of FIG. 2 allows for determining how many dropped calls there are within a given day. It is also possible to determine the uncertainty of that determination within uncertainty limits that can be determined using known analysis techniques.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
repeatedly alternating between a baseline network configuration and a trial network configuration a plurality of times within a twenty-four hour period.

2. The method of claim 1, comprising:
using a selected sample period duration within a range from about fifteen minutes to about four hours for each use of the baseline and trial network configurations.

3. The method of claim 2, wherein the sample period duration is about one hour.

4. The method of claim 1, comprising:
using a selected sample period for each use of the baseline and trial network configurations; and
selecting one of the baseline or the trial network configuration for each sample period.

5. The method of claim 4, comprising:
selecting the baseline network configuration for each sample period that is subsequent to and adjacent a sample period when the trial network configuration is used; and
selecting the trial network configuration for each sample period that is subsequent to and adjacent a sample period when the baseline network configuration is used.

6. The method of claim 4, comprising:
randomly selecting one of the baseline or the trial network configurations for each of the sample periods.

7. The method of claim 6, comprising:
selecting the baseline network a number of times that is approximately equal to a number of times selecting the trial network over a testing time period.

8. The method of claim 7, wherein the testing time period comprises at least one week.

9. The method of claim 4, comprising:
selecting a sample period duration that results in a determined plurality of sample periods within the twenty four period such that some of the determined plurality of sample periods are even numbered sample periods and others of the determined plurality of sample periods are odd numbered sample periods;
selecting the baseline network configuration for each of the even numbered sample periods during a first twenty-four hour period; and
selecting the baseline network configuration for each of the odd numbered sample periods during a second, different twenty-four hour period.

10. The method of claim 9, comprising
selecting the trial network configuration for each of the odd numbered sample periods during the first twenty-four hour period; and
selecting the trial network configuration for each of the even numbered sample periods during the second, different twenty-four hour period.

11. The method of claim 1, comprising
repeating the alternating over a plurality of twenty-four hour periods; and
determining at least one performance characteristic of the trial network configuration relative to a corresponding performance characteristic of the baseline network using information regarding the at least one characteristic over the plurality of twenty-four hour periods.

12. The method of claim 11, comprising
using an aggregate analysis of the at least one characteristic to determine an average difference between the trial network configuration and the baseline network configuration.

13. The method of claim 11, comprising
using at least a selected plurality of sample periods from within the plurality of twenty-four hour periods for analyzing the at least one characteristic to determine a specific difference between the trial network configuration and the baseline network configuration.

14. The method of claim 13, comprising
determining an uncertainty associated with the determined specific difference.

15. A method of testing a trial network configuration, comprising:
using a sample period duration during which the trial network configuration is active that is less than about four hours.

16. The method of claim 15, comprising
using a sample period duration that is about one hour.

17. The method of claim 15, comprising
repeatedly alternating between the trial network configuration and a baseline network configuration over a period of about twenty-four hours.

18. The method of claim 15, comprising
using a selected sample period for each use of the baseline and trial network configurations;
selecting the baseline network configuration for each sample period that is subsequent to and adjacent a sample period when the trial network configuration is used; and
selecting the trial network configuration for each sample period that is subsequent to and adjacent a sample period when the baseline network configuration is used.

19. The method of claim 15, comprising
using a selected sample period for each use of the baseline and trial network configurations; and
randomly selecting one of the baseline or the trial network configuration for each of the sample periods.

20. The method of claim 15, comprising:
using the sample period duration repeatedly within a twenty-four hour period;
alternating between the trial network configuration and a baseline network configuration;
selecting the baseline network configuration for each even numbered sample period during a first twenty-four hour period; and
selecting the baseline network configuration for each odd numbered sample period during a second, different twenty-four hour period.
